(19) United States
(12) Patent Application Publication
(10) Pub. No.: US 2014/0157727 A1
(43) Pub. Date: Jun. 12, 2014

(54) Package Containing a Breachable Bubble in Combination with a Closure Device

(71) Applicant: POPPACK, LLC, San Francisco, CA (US)

(72) Inventors: William Perrell, San Francisco, CA (US); Leif Sorensen, Cape Canaveral, FL (US)

(73) Assignee: POPPACK, LLC, San Francisco, CA (US)

(21) Appl. No.: 14/182,435

(22) Filed: Feb. 18, 2014

Related U.S. Application Data
(62) Division of application No. 12/704,914, filed on Feb. 12, 2010.

(51) Int. Cl. B65B 5/02; B31B 23/00; B31B 1/16; B31B 1/90; B31B 1/62

(52) U.S. Cl. CPC B65B 5/022; B31B 1/90; B31B 1/62; B31B 1/16; B31B 23/00
USPC 53/455; 493/212; 493/213; 493/194; 493/220

(57) ABSTRACT

A sealed package is disclosed that includes a breachable bubble for opening the package in combination with at least one reclosable device. The reclosable device may comprise a pair of opposing interlocking members. The breachable bubble allows for the package to be easily opened while the reclosable device allows for the package to be closed once opened. The breachable bubble and the reclosable device can be preformed on opposing strips that are then incorporated into the package as the package is being formed.

### RELATED APPLICATION

The present application is a Divisional Application of U.S. application Ser. No. 12/704,914, filed Feb. 12, 2010.

### BACKGROUND

Many products are packaged in flexible film bags. In some applications, especially when containing perishable food items, the packages are designed to be opened and closed repeatedly. In this manner, once the package is opened, a portion of the contents can be removed by a consumer and then the package can be closed for storing the remainder of the contents. When containing food items, the package can include a reclosable device that can protect the food product during further storage.

Particular types of reclosable devices include, for instance, interlocking members such as a groove positioned opposite a ridge that fit together and close when pressed against each other. Such closure devices, in one embodiment, can include a traversing head or “slider” that helps bring the interlocking members together in a zipper-like way.

When reclosable devices are incorporated into packages as described above, the packages can be initially sealed to prevent against tampering and further protect the contents during shipping. For instance, the package may include a sealed margin area positioned above the reclosable device that can be opened by tugging, tearing or cutting. Recently, in order to facilitate opening of such packages, the packages have included perforation lines or have included a tab that runs through a margin area and is to be pulled by the consumer in order to open the package.

Although perforating the packaging or including a pull away tab can somewhat facilitate the opening of the package, problems still persist. For instance, the packages must still remain tamper proof and must be capable of withstanding normal pressures exerted on the packages during shipping and storage. Thus, significant effort is still required to initially open many packages. Sometimes, when consumers are exerting force on the package in order to open it, they obliterate or damage the reclosable device rendering it useless. In view of the above, a need exists for an opening device that makes it easier to open packages containing reclosable devices.

### SUMMARY

In general, the present disclosure is directed to a package made from a flexible polymer film or from a semi-rigid polymer film that includes a reclosable device in combination with a breachable bubble. The breachable bubble facilitates initial opening of the package. For example, applying pressure to the bubble causes a pair of opposing panels to separate. The separated panels can then be easily peeled apart in order to gain access to the contents of the package. Of particular advantage, the closure system of the present disclosure can be manufactured separately and then added to a package as the package is being produced and/or as the package is being filled with a product.

For instance, in one embodiment, the present disclosure is directed to a closure system for a package. The closure system includes first and second opposed strips that are adapted to be attached to opposing panels of a package. The first and second opposed strips include a reclosable device located along a first portion of the length of each strip. The reclosable device is configured to attach the first strip to the second strip and close the package, once the package has been opened.

In accordance with the present disclosure, the first and second strips further include a breachable bubble that is positioned along a second portion of the length of the strips. The breachable bubble is positioned adjacent to the top of the strips, i.e. between the reclosable device and an edge of the package. The strips are configured to be sealed together at least around the perimeter of the bubble. The breachable bubble is configured to breach in a direction opposite the reclosable device when sufficient pressure is applied causing the strips to separate. In this manner, a user can peel the strips apart for opening the package and gaining access to the contents.

The package can be made from a flexible film and can include a first panel facing an opposing second panel. The package can include a top and a bottom and the first and second opposed strips can be attached to the top of the package. Incorporating a breachable bubble as described above allows for the package to be easily opened by a consumer. Incorporating a bubble into the package also eliminates the need for including perforations along the top of the package or for incorporating some type of pull tab.

The reclosable device included with the strips can vary depending upon the particular application. In one embodiment, for instance, the reclosable device may comprise interlocking members. For instance, a first profiled portion may be located along the first strip opposite a second profiled portion located on the second strip. The first profiled portion may interlock with the second profiled portion when pressed together. In one embodiment, for instance, the first profiled portion may comprise a groove, while the second profiled portion may comprise a rib that fits within the groove.

In an alternative embodiment, the reclosable device may comprise a first portion located on the first strip opposite a second portion located on a second strip. The first portion may comprise a pressure sensitive adhesive while the second portion may comprise a release layer.

The closure system of the present disclosure can be incorporated into the package using various methods and techniques. In one embodiment, for instance, the first and second strips may be spirally wound on separate spools prior to being incorporated into the package. The first strip, for instance, can be cut from a first spool and attached to one side of the package while the second strip may be cut from a second spool and attached to a second side of the package. The breachable bubble can be formed in between the strips and inflated as the package is sealed. In another embodiment, the first and second strips may be spirally wound on the same spool prior to being incorporated into the package. For example, the breachable bubble can be formed in between the strips and pre-inflated. The first and second strips, with the breachable bubble formed therebetween, can be cut from the spool and attached to the first and second sides of the package as the package is sealed.

The size and shape of the breachable bubble can vary depending upon various factors. In one embodiment, for instance, the breachable bubble may have a round shape and can be positioned anywhere along an edge of the package. The breachable bubble can extend over only a portion of the width of the package or over the entire width. For instance, in one embodiment, the breachable bubble extends over less than 20% of the width of the package, while in an alternative embodiment, the breachable bubble may extend over at least about 70% of the width of the package. In still another embodiment, the package may include more than one breachable bubble positioned along an edge of the package.

Other features and aspects of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a plan view of one embodiment of a package made in accordance with the present disclosure;

FIG. 2 is a plan view of an alternative embodiment of the package made in accordance with the present disclosure;

FIG. 3 is a cross-sectional view of one embodiment of a closure system that can be incorporated into packages made according to the present disclosure, shown prior to the formation of a breachable bubble therein;

FIG. 4 is a cross-sectional view of an alternative embodiment of a closure system that can be incorporated into packages made according to the present disclosure, shown after the formation of a breachable bubble therein;

FIG. 5 is a perspective view of one embodiment of one embodiment of a process for making packages in accordance with the present disclosure; and

FIG. 6 is a perspective view of an alternative embodiment of a process for making packages in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present invention.

In general, the present disclosure is directed to a closure system for a package. The closure system is particularly well suited for use with packages made from flexible polymer films. The closure system generally comprises a reclosable device in combination with a breachable bubble for initially opening the package.

For example, packages of the present disclosure, after being filled with a product, are sealed for shipment prior to use. In accordance with the present disclosure, the package includes a breachable bubble that facilitates opening of the package. Breaching the bubble, for instance, can cause two layers of the package to separate. The separated film layers can then be peeled away from each other for gaining access to the contents of the package. Once the contents have been partially consumed or it is otherwise desired to store the package for further use, the reclosable device can then be used to close the package.

In the past, instead of including a breachable bubble, such packages typically included a perforated area or a pull tab for opening the package. Packages as described above containing perforations, however, are typically still very difficult to open. Pull tabs, on the other hand, have a tendency to malfunction or are otherwise difficult to operate. Use of the breachable bubble, however, renders the package much easier to open while still providing the package with sufficient resiliency to withstand shipping.

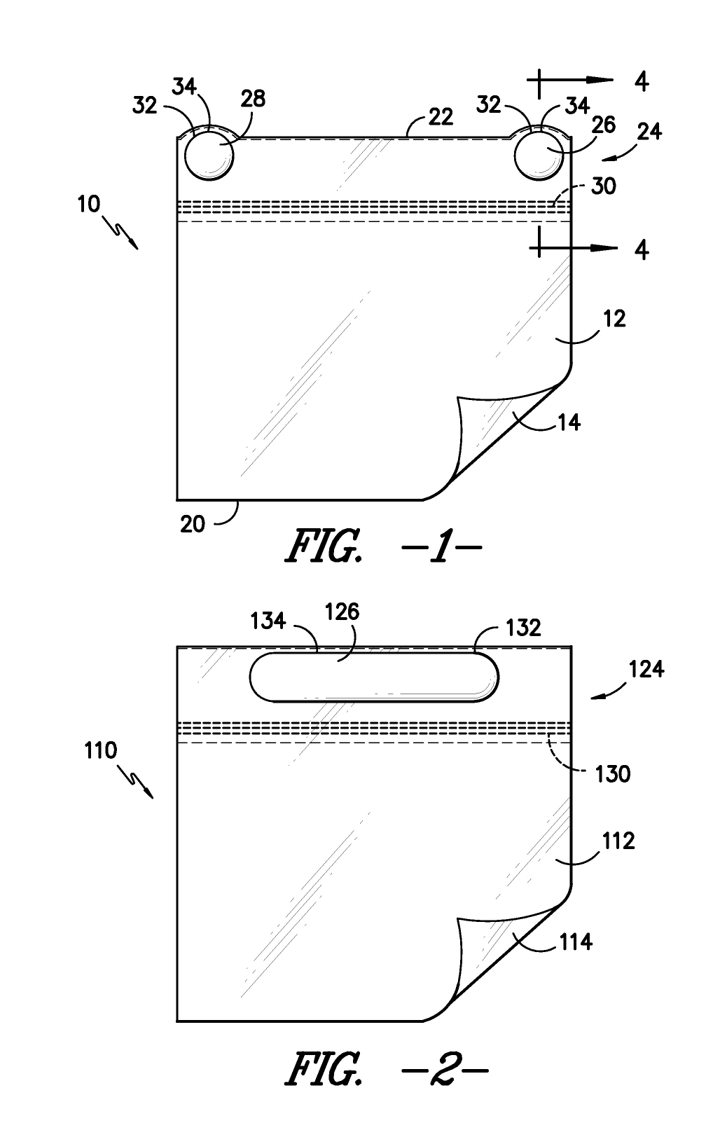

Referring to FIG. 1, one embodiment of a package 10 made in accordance with the present disclosure is illustrated. As shown, the package 10 includes a front or first panel 12 spaced from a back or second panel 14. In this embodiment, the first panel 12 is sealed to the second panel 14 along a perimeter of the package. The package 10 generally has a rectangular shape.

In the embodiment illustrated in FIG. 1, the package 10 is formed from a flexible polymer film. It should be understood, however, that the package can be made from any suitable material. For instance, the package 10 can be made from paper or from a fabric such as a woven or nonwoven material. When made from a film material, the package can be made from any suitable polymer. The polymers that may be used to form the package include, for instance, polyolefins such as polyethylene and polypropylene, polyesters, polyamides, polyvinyl chloride, mixtures thereof, copolymers thereof, terpolymers thereof, and the like. In addition, the package can also be made using any suitable elastomeric polymer.

The material used to form the package 10 can comprise a single layer of material or can include multiple layers. For instance, when the package is made from a polymer film, the film can include a core layer of polymeric material coated on one or both sides with other functional polymeric layers. The other functional polymeric layers may include, for instance, a heat sealing layer for thermally bonding the film together at desired locations, an oxygen barrier layer, an ultraviolet filter layer, an anti-blocking layer, a printed layer, or the like.

When made from a polymer film, the package 10 can be translucent or transparent. If translucent or transparent, for instance, the contents of the package can be viewed from the outside. In other embodiments, however, the package can be opaque. For instance, in one embodiment, the package can display various graphics that identify the brand and the description of the product inside.

Although a rectangular package is shown in FIG. 1, it should be understood that the package can also have any suitable shape. The package, for instance, can be in the shape of a cylinder or may include side panels that provide more of a three dimensional package.

The package 10 shown in FIG. 1 includes a bottom 20 and a top 22. Adjacent to the top 22 is a closure system 24 made in accordance with the present disclosure.

As shown in FIG. 1, the closure system 24 includes breachable bubbles 26 and 28 in combination with a reclosable device 30. The breachable bubbles 26 and 28 are for initially opening the package 10. The reclosable device 30, on the other hand, is for closing the package after the package has been opened.

In the embodiment illustrated in FIG. 1, the package 10 includes a first breachable bubble 26 and a second breachable bubble 28. The breachable bubbles are positioned on opposite sides at the top 22 of the package 10 adjacent to each corner of the package. It should be understood, however, that the breachable bubbles can be positioned anywhere above the reclosable device 30 adjacent to an edge of the package.

Although two breachable bubbles are illustrated in FIG. 1, it should also be understood that the package may contain more or less breachable bubbles as desired. The breachable bubbles 26 and 28 can also have any suitable shape. For example, the bubbles can be circular as shown in the figure. In other embodiments, however, the bubbles can have a triangular shape, a rectangular shape, or can even have a heart-like shape. In still other embodiments, the bubble can be in the shape of an oval. Further, the bubbles can be relatively small on the package or they can be relatively large. In the embodiment illustrated in FIG. 1, for instance, each bubble extends only over a relatively minor portion of the width of the package. In FIG. 1, for instance, the bubbles have a dimension such that they extend over less than 20% of the width of the package 10.

The breachable bubbles 26 and 28 can be formed between the first panel 12 and the second panel 14 of the package using various different techniques and methods. The bubbles 26 and 28 can also be formed so as to project only upwards from the package, only downwards from the package, or both upwards and downwards. Breachable bubbles that may be used in association with the package 10, for instance, are described in U.S. Pat. Nos. 6,726,364; 6,938,394; 7,306,371; and U.S. Patent Publication Numbers 2007/0284375; 2007/0235369; 2007/0286535; 2007/0237431; 2007/0295766; 2007/0241024; and 2007/0235357, which are all incorporated herein by reference.

As described above, the breachable bubbles 26 and 28 are for initially opening the package and are intended to produce peel away portions that allow a user access to the contents. In one embodiment, for instance, each breachable bubble may be surrounded and defined by a seal that is at least partially breachable. For instance, as shown in FIG. 1, the breachable bubbles 26 and 28 can each be surrounded by a seal 32. The bubble seal 32 can include a breachable portion 34 that faces an edge of the package 10. The breachable portion 34 represents a portion of the bubble seal 32 that more easily separates than the remainder of the seal or otherwise more easily causes an edge breach. The breachable portion 34 can be made using any suitable method or technique. For instance, in one embodiment, the bubble seal 32 comprises a peel seal. In this embodiment, the breachable portion 34 can be formed by interfering with the peel seal along the breachable portion 34. For instance, the breachable portion can be made by using less adhesive, varying the pressure of the seal bar, varying the temperature, or varying the amount of time the seal bar is in contact with the material along the breachable portion. In an alternative embodiment, the breachable portion 34 is created where the bubble seal has a minimum length.

The breachable bubbles 26 and 28 are expanded to open the package 10 by external pressure applied by a user. For smaller bubbles, the consumer may simply pinch a bubble or bubbles between his or her thumb and forefinger. Slightly larger bubbles may require thumb-to-thumb pressure. Pressure can also be applied to the bubble by placing the bubble against a flat surface and applying pressure with one's finger or palm.

Applying pressure to one of the bubbles 26 or 28 causes the bubble to spread into the bubble seal 32 and specifically through the breachable portion 34. Ultimately, the first panel 12 separates from the second panel 14 of the package until an edge breach occurs along the perimeter of the package. Once the first panel 12 is separated from the back panel 14 at an edge breach, each panel can form a peelable portion. A user can than grasp each peelable portion and peel the two panels apart until an access opening is formed for access to the contents of the package.

In the embodiment illustrated in FIG. 1, the breachable bubbles 26 and 28 include a breachable portion 34 that creates an edge breach either along the top edge of the package or along the side edge of the package. The breachable bubble 26 or 28, however, may operate to separate the first panel 12 from the second panel 14 in other ways. For example, in an alternative embodiment, the bubble can “pop” without spreading thereby forming peelable portions that can be used to open the package.

The reclosable device 30 used in conjunction with the breachable bubbles 26 and 28 can comprise any suitable device capable of closing the package after the package has been opened. For instance, in one embodiment, the reclosable device 30 may comprise opposing interlocking members. For instance, in one embodiment, the reclosable device 30 may include a groove or grooves attached to one of the panels of the package opposite a corresponding rib or ribs. The rib can be designed to interlock with the groove when the two components are pushed together. The interlocking members can be pressed into engagement by a user when it is desired to close the package, or the reclosable device 30 may include a traversing head or slider that runs along the interlocking members for causing them to engage much like a zipper.

In addition to interlocking members, the reclosable device 30 may comprise various other configurations. For instance, in an alternative embodiment, the reclosable device 30 may comprise a pressure sensitive adhesive layer positioned opposite a release liner.

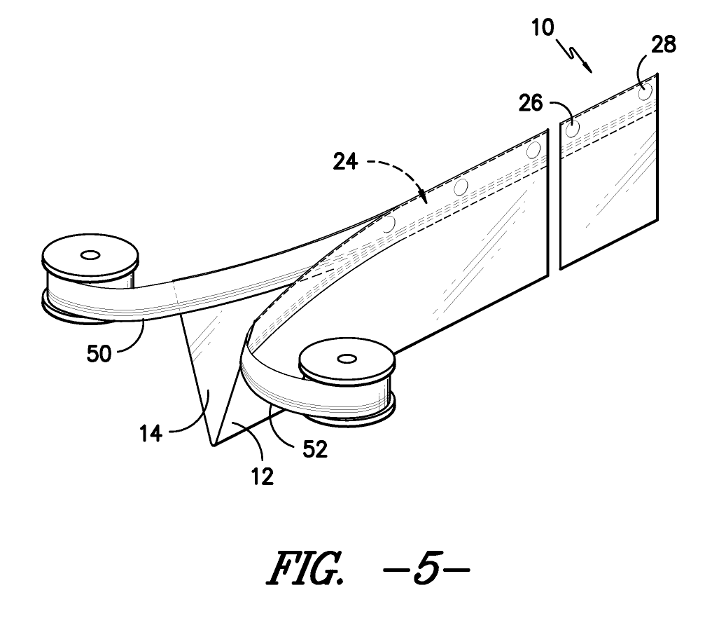

Referring to FIGS. 3 and 4, one embodiment of a closure system in accordance with the present disclosure is shown that may be used in conjunction with the package illustrated in FIG. 1. FIG. 3 illustrates one embodiment of the closure system 24 prior to the formation of one or more breachable bubbles therein, while FIG. 4 illustrates one embodiment of the closure system 24 after the formation of the breachable bubbles. As shown in FIG. 4, the closure system 24 includes a breachable bubble 26 that, in the embodiment illustrated, is formed between two strips 50 and 52. The breachable bubble 26 is surrounded by a bubble seal 32.

As described above, the bubble seal 32 may comprise a peel seal. In fact, the peel seal can attach the first panel 12 to the second panel 14 of the package along the entire top portion of the package. More particularly, the peel seal can be used not only to facilitate formation of the breachable bubble but also can be used to seal the package along a margin in between the reclosable device 30 and an outer edge of the package. Sealing the entire margin area of the package as shown in FIG. 1 also facilitates formation of the breachable portion 34. For instance, as shown in FIG. 1, in one embodiment, the breachable portion 34 automatically forms where the peel seal has a minimum distance to the edge of the package.

Various different methods and techniques can be used to form peel seals. For example, in one embodiment, the peel seal may include a first portion that is adhesively secured to a second portion along the seal. The first portion, for instance, may be located on the first strip 50, while the second portion may be located on the second strip 52. The first portion may comprise a pressure sensitive adhesive. The adhesive may comprise, for instance, any suitable adhesive, such as an acrylate.

The second and opposing portion of the peel seal, on the other hand, may comprise a release layer. The release layer, for instance, may be coated or adhered to the second strip 52. In one embodiment, the release layer may comprise a silicone or a wax.

In an alternative embodiment, each opposing portion of the peel seal may comprise a multi-layered film. The major layers of the film may comprise a supporting layer, a pressure sensitive adhesive component, and a thin contact layer. In this embodiment, the two portions of the peel seal can be brought together and attached. For instance, the thin contact layer of one portion can be attached to the thin contact layer of the opposing portion using heat and/or pressure. When the strips and/or panels of the package are pulled apart, part of the sealed area of one of the contact layers tears away from its pressure sensitive adhesive component and remains adhered to the opposing contact layer.

In the above embodiment, the contact layer can comprise a film having a relatively low tensile strength and having a relatively low elongation at break. Examples of such materials include polyolefins, such as polyethylenes, copolymers of ethylene and ethylenically unsaturated comonomers, copolymers of an olefin and an ethylenically unsaturated monocarboxylic acid, and the like. The pressure sensitive adhesive contained with the layers, on the other hand, may be of the hot-melt variety or otherwise responsive to heat and/or pressure.

In still another embodiment, the peel seal may include a combination of heat sealing and adhesive sealing. For instance, the peel seal may comprise a first portion that is heat sealed to a second portion.

In order to form the breachable bubble 26 in between the peel seal layers 32 as shown in FIG. 4, various different techniques and methods may be used. For example, in one embodiment, the peel seal coating can be present on the entirety of each strip above the reclosable device 30, as shown in FIGS. 3 and 4. In another embodiment, the peel seal coating can be absent from each strip where the breachable bubble is to be formed. In yet another embodiment, a composition can be applied to portions of one or both strips that interferes with the ability of the peel seal layers to attach together. For instance, in one embodiment, a coating, such as a lacquer, can be applied between the two strips 50 and 52 that prevents the strips from attaching together where the coating is located.

In accordance with the present disclosure, the breachable bubble 26 is present in combination with a reclosable device 30. In one embodiment, the reclosable device includes a first interlocking member 36 opposite a second interlocking member 38. As shown, each interlocking member 36 and 38 includes ribs 40 that extend into corresponding grooves 42 for closing the package 10 after the package has been opened.

The closure system as shown in FIGS. 3 and 4 can be incorporated into the package 10 as shown in FIG. 1 using any suitable method or technique. In one embodiment, for instance, the reclosable device 30 may be first incorporated into the package 10 followed by the creation of one or more breachable bubbles. In another embodiment, one or more breachable bubbles may be first created between the first and second strips, each of which include a reclosable device 30, and the first and second strips may then be incorporated into the package 10.

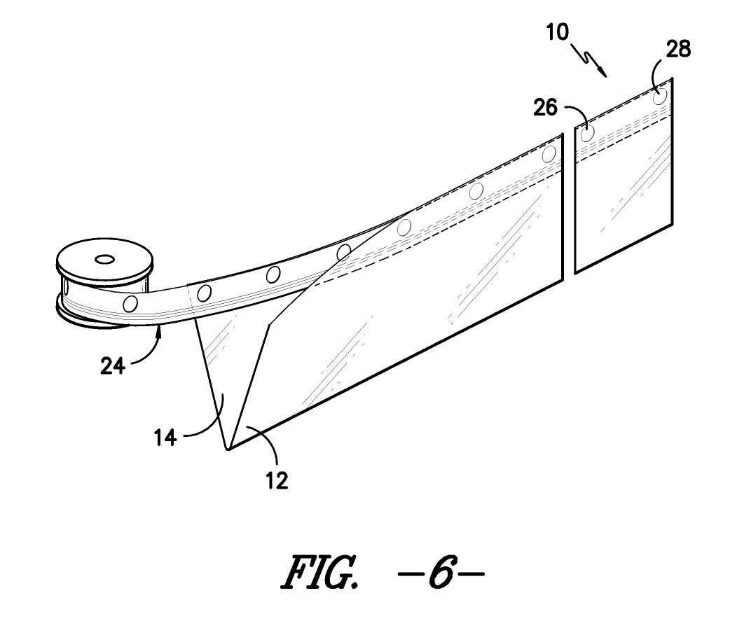

In one embodiment illustrated in FIG. 5, for example, the reclosable device can be first produced on separate strips that are then attached to opposing panels of the package. In this embodiment, for instance, the strips can be adhered or welded to opposing sides of the package while the package is being formed. For instance, the opposing strips can be unwound from supply rolls, cut to length, and attached to opposing sides of the package. One or more breachable bubbles can be formed between the strips as the package is sealed.

In another embodiment illustrated in FIG. 6, however, the entire closure system can be produced between the first strip and second strip, and the strips can then be attached to opposing panels of the package. In this embodiment, for instance, one or more breachable bubbles can first be formed between the first and second strips. The strips can then be adhered or welded to the opposing sides of the package as the package is being formed. For instance the opposing strips, with one or more breachable bubbles formed therebetween, can be unwound from a single supply roll, cut to length, and attached to the opposing sides of the package.

As shown in FIG. 3, for example, the closure system 24 includes the first strip 50 opposite the second strip 52. The strips can be made from a single layer of material or can be made from multiple layers of material as shown. In one embodiment, for instance, each strip can include a base layer 54, a second layer 56, and an outer layer 58. The base layer 54 generally comprises any suitable polymer layer. The base layer 54, for instance, can be made from a polyolefin, such as polyethylene, polypropylene, mixtures thereof, or copolymers thereof.

The second layer 56, on the other hand, may comprise any suitable tie layer capable of attaching the interlocking members to the base layer. In one embodiment, for instance, the second layer 56 can comprise an extrudable adhesive.

The outer layer 58, on the other hand, comprises any suitable material capable of forming the interlocking members.

Once the strips 50 and 52 are formed, the strips can be wound on a reel for later incorporation into the package. For instance, referring to FIG. 5, one exemplary embodiment of a process for incorporating the strips 50 and 52 into a package is shown. As illustrated, the strips 50 and 52 are produced in advance and wound onto spools. The strips can be produced using, for instance, co-extrusion, especially when the strips have more than one layer. In the embodiment illustrated in FIG. 5, the strips 50 and 52 are applied to opposing panels of a V-folded sheet. Alternately, the strips 50 and 52 may be applied at opposite ends to a flat, unfolded sheet that is then folded together. The sheet can be made, for instance, from any of the flexible polymer materials described above. The strips 50 and 52 can be attached to opposing sides of the folded sheet using any suitable method or technique. For instance, the strips can be adhesively secured to the polymer film or can be thermally or ultrasonically bonded to the polymer film.

After the strips 50 and 52 are applied to the panels 12 and 14, the V-folded sheet of material is cut to form the package 10. During the cutting operation, the sides of the package can be sealed together. For instance, the sides of the package can be welded together. In addition, suitable equipment can be used to attach the peel seal layers together along the top edge of the package. During the sealing process, the breachable bubbles 26 and 28 can be formed between the strips 50 and 52 and inflated as desired.

In another embodiment as illustrated in FIG. 6, the strips 50 and 52 are produced in advance. The strips 50 and 52 can then be sealed together, forming breachable bubbles 26 and 28. The first and second strips 50 and 52, forming closure system 24 and having breachable bubbles 26 and 28 formed therebetween, may then be wound onto a spool. The first and second strips 50 and 52, as closure system 24, may then be applied to the panels 12 and 14 as the panels 12 and 14 are sealed together, and the material may be cut to form the package 10.

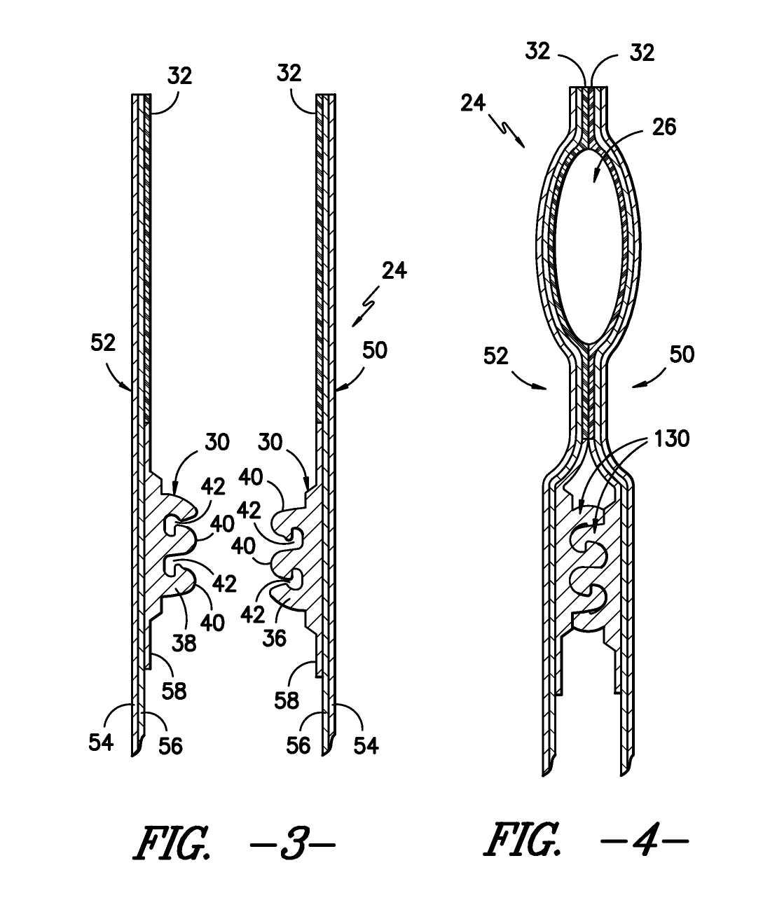

Referring to FIG. 2, another embodiment of a package 110 made in accordance with the present disclosure is shown.

The package 110 includes a single breachable bubble 126. The breachable bubble 126 is defined by a bubble seal 132 having a breachable portion 134. The breachable bubble 126 is generally in the shape of an oval and extends over a substantial portion of the width of the package. In this embodiment, for instance, the bubble extends over greater than 50% of the width of the package, such as greater than 70% of the width of the package. In one embodiment, for instance, the bubble may extend over greater than 90% of the width of the package. The strips 50 and 52 as shown in FIGS. 3 and 4 can be incorporated into the package 110 using the same processes as shown in FIG. 5 or 6.

During the processes of producing the package 10 as shown in FIGS. 5 and 6, the package can be filled with any suitable product. For instance, in one embodiment, the package may contain a perishable food item or may contain any other product as desired.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A method of manufacturing a package, the method comprising:
attaching a first strip to a first panel and a second strip to a second panel, the first and second panels forming a chamber having a width, the first and second strips being attached to the first and second panels along an open end thereof, the first and second strips extending along the width of the chamber, the first and second opposed strips having a length that extends from a top to a bottom;
attaching a reclosable device to the first and second opposed strips along a first portion of the length, the reclosable device being configured to releasably attach the first strip to the second strip;
forming one or more breachable bubbles between the first and second strips along a second portion of the length, the one or more breachable bubbles being positioned adjacent to an edge of the package, the one or more breachable bubbles being configured to breach in a direction opposite to the reclosable device when sufficient pressure is applied causing the strips to separate and allowing a user to peel the strips apart for access to the chamber.

2. The method of claim 1, further comprising sealing the first and second panels so as to form the chamber.

3. The method of claim 1, further comprising the step of placing an item within the chamber.

4. The method of claim 1, further comprising unwinding the first and second strips from separate spools prior to attaching the first and second strips to the first and second panels, the first strip being cut from a first spool when incorporated into the package and the second strip being cut from a second spool when incorporated into the package.

5. The method of claim 4, further comprising, after attaching the first and second strips to the first and second panels, sealing the first and second strips together, and inflating an area between the first and second strips as the package is sealed so as to form the one or more breachable bubbles.

6. The method of claim 1, further comprising unwinding the first and second strips from a single same spool, and before attaching the first and second strips to the first and second panels, inflating an area between the first and second strips such that the one or more breachable bubbles are pre-inflated therein.

7. The method of claim 6, further comprising cutting the first and second strips, with the one or more breachable bubbles formed therebetween, from the single spool and attaching the first and second strips to the first and second panels.

8. The method of claim 1, further comprising attaching the first and second opposed strips to a top of the package.

9. The method of claim 1, wherein the one or more breachable bubbles are spreadable under applied pressure causing the first strip to separate from the second strip until the bubble produces an edge breach through an edge of the closure system to the exterior environment.

10. The method of claim 9, wherein the edge breach forms peelable portions for separating the first strip from the second strip.

11. The method of claim 1, further comprising sealing the one or more breachable bubbles such that each breachable bubble is surrounded by a peel seal, wherein the peel seal comprises a first portion located on the first strip opposite a second portion located on the second strip, the first portion comprising a pressure sensitive adhesive, the second portion comprising a release layer.

12. The method of claim 1, wherein the reclosable device includes a first profiled portion located on the first strip opposite a second profiled portion located on the second strip, the first profiled portion interlocking with the second profiled portion when pressed together.

13. The method of claim 1, further comprising positioning a peel seal material around at least one of one or more breachable bubbles.

14. The method of claim 13, further comprising applying a coating to the first and second strips that interferes with the peel seal material where the one or more breachable bubbles are formed.

15. The method of claim 1, wherein the package has a width and wherein the one or more breachable bubbles extend over at least about 70% of the width of the package.

16. The method of claim 1, wherein the package has a width and wherein the one or more breachable bubbles extend over less than 20% of the width of the package.
